(19) United States
(12) Patent Application Publication
(10) Pub. No.: US 2014/0015359 A1
(43) Pub. Date: Jan. 16, 2014

(54) BUSS BAR ASSEMBLY HAVING PRINTED BUSS BAR PLATES

(71) Applicant: Remy Technologies, LLC, Pendleton, IN (US)

(72) Inventors: Bradley D. Chamberlin, Pendleton, IN (US); Cary Ramey, Greenwood, IN (US); Colin Hamer, Noblesville, IN (US)

(21) Appl. No.: 13/939,121

(22) Filed: Jul. 10, 2013

Related U.S. Application Data
(60) Provisional application No. 61/670,189, filed on Jul. 11, 2012.

(51) Int. Cl. H02K 3/50; H02K 15/00

(52) U.S. Cl. CPC H02K 3/50; H02K 15/0062
USPC 310/71; 29/596

(57) ABSTRACT

A buss bar assembly for a multiphase electric machine. The buss bar assembly includes a substantially annular dielectric housing having a central axis. A plurality of dielectric mounting members is located within the housing. A buss bar plate assembly is disposed in the housing, and in engagement with the mounting members. The buss bar plate assembly includes a substantially planar dielectric substrate that has opposing, substantially planar axial sides, and substantially surrounds the central axis. The buss bar plate assembly also includes a plurality of electrically conductive phase bars applied to at least one of the opposing substrate sides. Each phase bar is for electrical connection to a different one of multiple electrical phases and substantially surrounds the central axis, with the phase bars being electrically isolated from each other within the housing.

### CROSS-REFERENCE TO RELATED APPLICATION(S)

This application claims the benefit under Title 35, U.S.C. §119(e) of U.S. Provisional Patent Application Ser. No. 61/670,189 entitled BUSS BAR ASSEMBLY HAVING PRINTED BUSS BAR PLATES, filed on Jul. 11, 2012, the entire disclosure of which is expressly incorporated herein by reference. This application is related to U.S. Provisional Patent Application Ser. No. 61/670,249, filed on Jul. 11, 2012, and to U.S. Patent Application Ser. No. 13/938,958, filed on Jul. 10, 2013 (Attorney Docket No. 22888-0123 (D-652 (US)), both entitled BUSS BAR ASSEMBLY HAVING AXIALLY STACKED BUSS BAR PLATES, the entire disclosures of which are incorporated herein by reference.

### BACKGROUND

The present disclosure relates to a rotating electrical device having a segmented, multiphase stator assembly that includes a plurality of individual coil winding assemblies disposed about a stator central axis and a plurality of electrical leads through which electrical power is transferred to or from the stator, such as, for example, an electric motor or generator; and more specifically, to a buss bar assembly through which the phase leads are interconnected and power is transferred.

The interconnecting of phase and neutral leads extending from a plurality of individual coil winding assemblies of the stator of a rotating electrical device (e.g., a motor or generator), which are annularly arranged about the stator central axis, is often complicated and/or time consuming. Moreover, the leads and/or their connections together or to other components can, if not properly isolated electrically, result in shorting which adversely affects device reliability.

These problems are exacerbated in multi-phase devices, wherein multiple phase power and neutral leads of different phase pluralities of individual power phase coil winding assemblies must be sorted out, electrically isolated from the leads of the coil winding assemblies of the other phases, and packaged within the stator housing, all of which have the potential to adversely affect cost and reliability.

A buss bar assembly is often employed for interconnecting the various phase and neutral leads of multiple individual coil winding assemblies, and typically promotes faster, more reliable interconnecting of the leads. However, the buss bar itself must be properly oriented, packaged and installed relative to the rest of the stator, preferably within the stator housing to protect it from externally-induced damage, and preferably in a manner that facilitates automated, consistent, and proper device assembly on a mass production scale. A buss bar assembly accommodating such preferences would represent an improvement in the relevant art and provide attendant cost and reliability advantages vis-à-vis those now used in rotating electrical devices.

### SUMMARY

A buss bar assembly and installation method according to the present invention provides such advantages, and hence represents a desirable advancement in the relevant art.

The present disclosure provides a buss bar assembly for a multiphase electrical machine. The buss bar assembly includes a substantially annular dielectric housing having a central axis. A plurality of dielectric mounting members is located within the housing. A buss bar plate assembly is disposed in the housing, and in engagement with the mounting members. The buss bar plate assembly includes a substantially planar dielectric substrate that has opposing, substantially planar axial sides, and substantially surrounds the central axis. The buss bar plate assembly also includes a plurality of electrically conductive phase bars applied to at least one of the opposing substrate sides. Each phase bar is for electrical connection to a different one of multiple electrical phases and substantially surrounds the central axis, with the phase bars being electrically isolated from each other within the housing.

A further aspect of the disclosure is that each of the plurality of mounting members is connected to the substantially annular dielectric housing.

A further aspect of the disclosure is that each phase bar includes a terminal for electrical connection to a different one of multiple electrical phases. The substantially annular dielectric housing defines a space in which the buss bar plate assembly is located and a wall having openings through which the phase bar terminals extend from the space.

A further aspect of the disclosure is that the housing has feet for fixing the buss bar assembly to a multiphase electrical machine stator.

A further aspect of the disclosure is that the buss bar plate assembly is provided with a plurality of apertures extending between the opposing axial sides of the substrate, through which a mounting member extends. The buss bar plate assembly and the mounting members are in abutting engagement at locations along the mounting members in directions generally parallel with the central axis.

An additional aspect of the disclosure is that the plurality of mounting members is distributed about the central axis.

An additional aspect of the disclosure is that each mounting member is defined by axially adjacent segments of different cross-sectional sizes. Between these segments is located a shoulder with which the buss bar plate assembly is in abutting engagement.

A further aspect of the disclosure is that each mounting member is an integrally formed portion of the housing. Each mounting member has an axis along which the mounting member extends in directions generally parallel with the central axis, and is in abutting engagement with the buss bar plate assembly.

A further aspect of the disclosure is that the buss bar plate assembly includes an electrically conductive neutral bar applied to one of the opposing substrate sides for electrical connection to multiple electrical phases. The neutral bar substantially surrounds the central axis, and is electrically isolated from the phase bars within the housing.

An additional aspect of the disclosure is that each phase bar includes a terminal for electrical connection to a different one of multiple electrical phases, and the neutral bar includes terminals for electrical connection to multiple electrical phases. The substantially annular dielectric housing defines a space in which the buss bar plate assembly is located, and at least one wall having openings through which the neutral bar terminals and phase bar terminals extend from the space.

An additional aspect of the disclosure is that the buss bar plate assembly is provided with a plurality of apertures extending between the opposing axial sides of the substrate and through which a mounting member extends. The buss bar plate assembly and the mounting members are in abutting engagement at locations along the mounting members in directions generally parallel with the central axis.

Moreover, an aspect of the disclosure is that each mounting member is defined by axially adjacent segments of different cross-sectional sizes between which is located a shoulder with which the buss bar plate assembly is in abutting engagement.

An additional aspect of the disclosure is that each mounting member has first portion connected to the housing, and a second portion axially adjacent and connected to the first portion. The substrate is provided with an aperture extending between its opposing axial sides, with each mounting member first portion restricted from insertion into an aperture. Each aperture surrounds a respective mounting member second portion.

Moreover, an aspect of the disclosure is that each aperture is substantially cylindrical and the first and second portions of each mounting member respectively define axially adjacent cylindrical segments of different cross-sectional sizes between which is located a shoulder with which the buss bar plate assembly is in abutting engagement.

The present disclosure also provides a method for manufacturing a buss bar assembly for a multiphase electrical machine. The method includes: providing a buss bar plate assembly having a plurality of electrically conductive phase bars, each phase bar for electrical connection to a different one of multiple electrical phases, the phase bars applied onto at least one of a pair of opposing, substantially planar axial sides of a dielectric substrate, the phase bars electrically isolated from each other on the substrate; substantially surrounding the central axis of an annular dielectric housing with the substrate and disposing the buss bar plate assembly in the housing such that each buss bar is electrically engageable from outside of the housing; and engaging the buss bar plate assembly with a plurality of dielectric mounting members fixed within the housing, whereby the buss bar plate assembly has a fixed position relative to the housing.

A further aspect of the disclosure is that the providing of a buss bar plate assembly includes providing a buss bar plate assembly having an electrically conductive neutral bar for electrical connection to multiple electrical phases applied to one of the axial sides of the substrate, the neutral bar electrically isolated from the phase bars on the substrate; and that the method also includes disposing the buss bar plate assembly in the housing such that the neutral bar is electrically engageable from outside of the housing.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a partially exploded view of a buss bar assembly shown mounted to the stator of a multiphase electrical machine, with portions of the printed buss bar plate omitted;

FIG. 2 is a partial, cross sectional view of the buss bar assembly;

FIG. 3 is a top plan view of the printed buss bar plate assembly of the buss bar assembly; and

FIG. 4 is a bottom plan view of the printed buss bar plate assembly shown in FIG. 3.

Corresponding reference characters indicated corresponding parts throughout the several views. Although the drawings represent an embodiment, the drawing are not necessarily to scale or to the same scale and certain features may be exaggerated in order to better illustrate and explain the present invention.

### DETAILED DESCRIPTION OF EXEMPLARY EMBODIMENT(S)

The embodiments described below are not intended to be exhaustive or to limit the invention to the precise forms disclosed in the following detailed description. Rather, the embodiments are chosen and described so that others skilled in the art may appreciate and understand the principles and practices of the present invention.

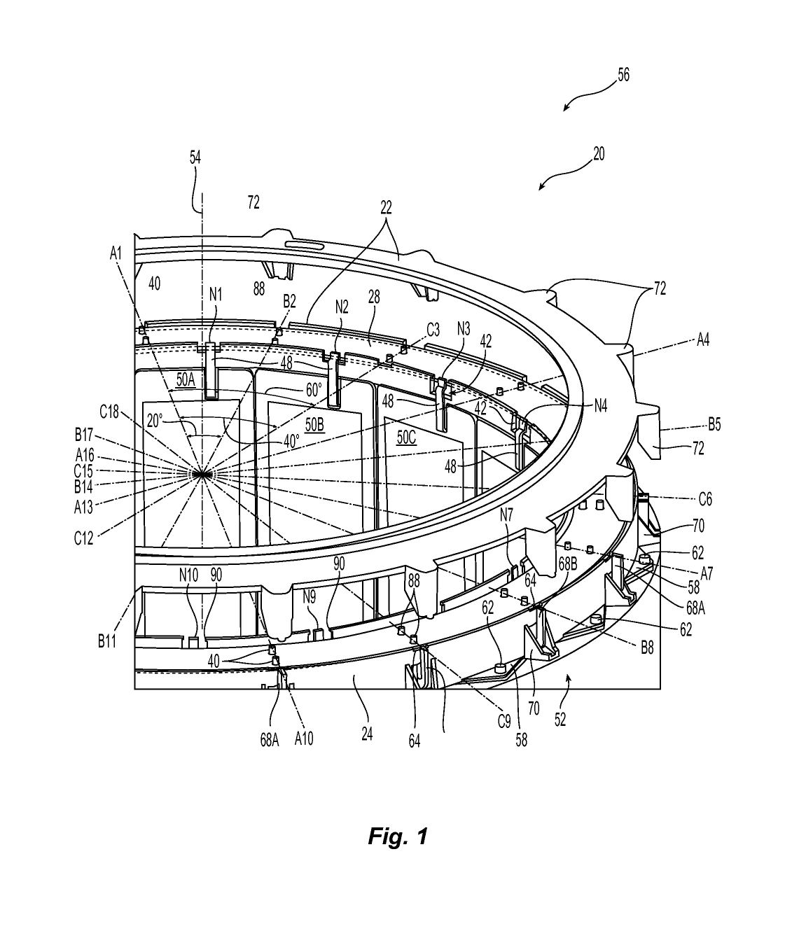

Referring to FIG. 1, buss bar assembly 20 includes a dielectric, injection molded plastic housing 22 that has a base 24 and a separably attachable cover 26. Within housing 22 is located a buss bar plate assembly 28 having a planar substrate 30 on which are applied a plurality of conductive buss bar plates 32, also referred to herein as bars 32, using methods known to those of ordinary skill in the art relating to printed circuit board (PCB) design and manufacture. Substrate 30 is typical of the types used in PCB technology, and may be, for example, a fiberglass material such as FR-4, or flexible FLEX material, or ceramic. Dielectric insulation between the buss bar plates 32 is provided through the substrate material, and epoxy may be used as the dielectric. In the disclosed embodiment, the flat, annular buss bar plate assembly 28 has opposing, planar sides, with two phase bars printed on one side (herein, the top side), and a third phase bar and an optional neutral bar printed on the opposite, bottom side. The disclosed locations and configurations of the buss bar plates 32 are exemplary, and may be altered as packaging, electrical load, cost and reliability considerations warrant.

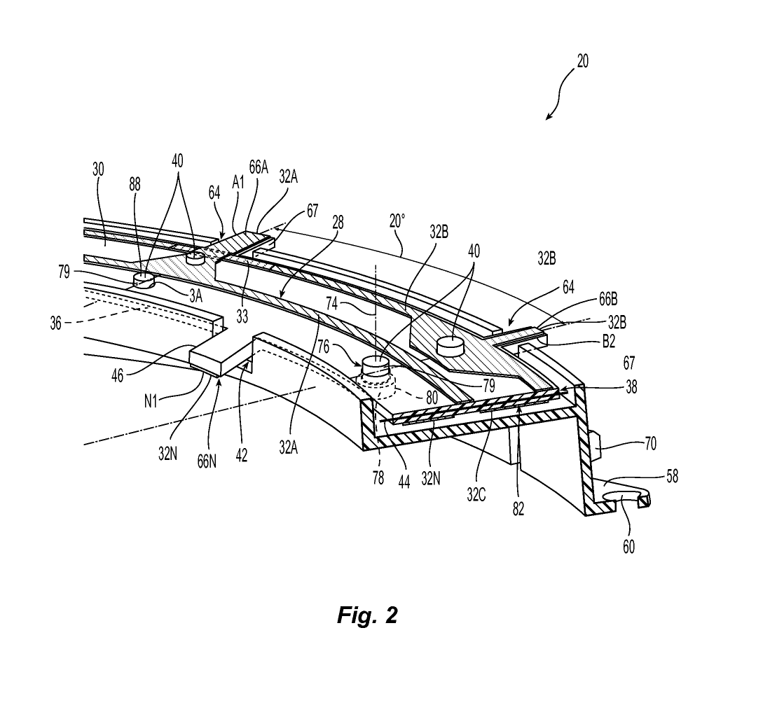

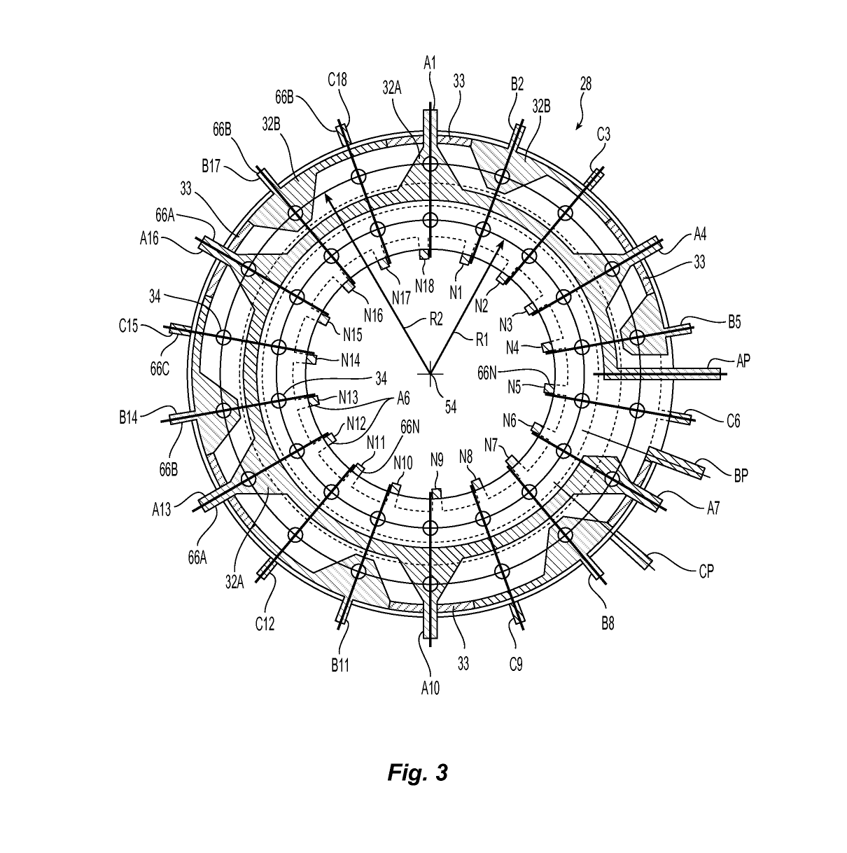

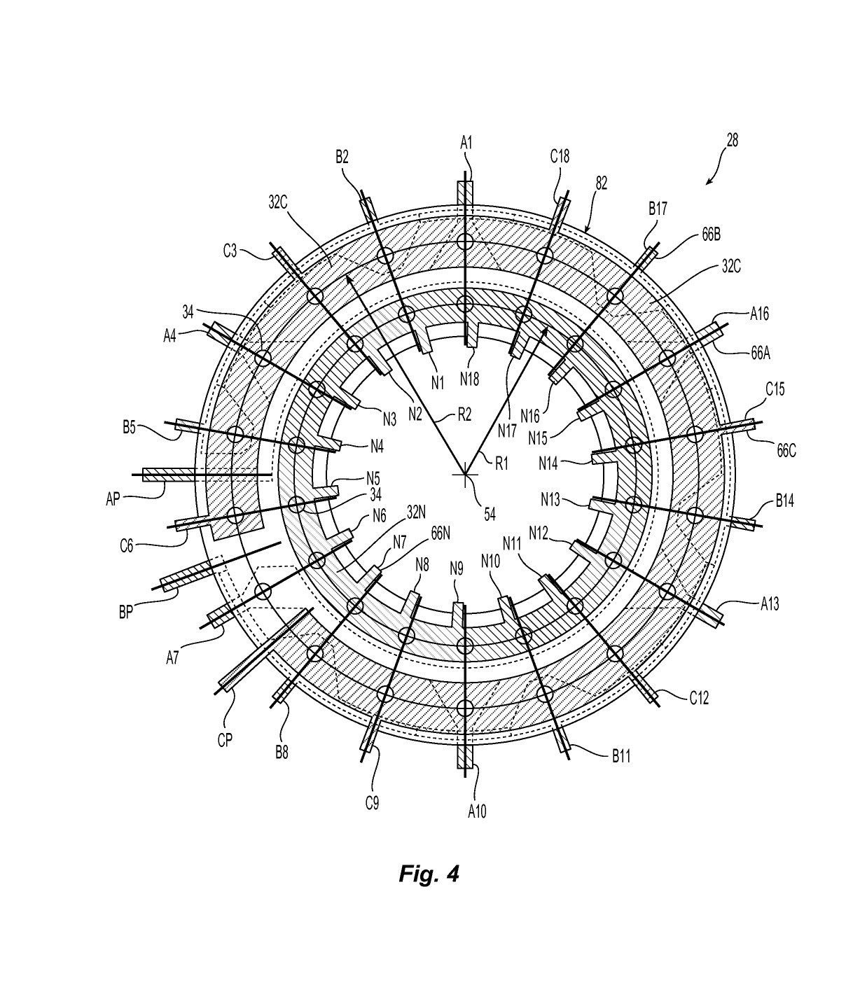

Each phase bar is individually connected to single electrical phase of the multiphase machine. In the depicted embodiment, there are three phases, A, B, and C; thus the phase bar assembly 20 includes a first phase bar 32A, second phase bar 32C, and third phase bar 32C, which are electrically isolated from each other. Interlayer insulation 33 is provided between overlapping traces or layers of the first and second phase bars 32A, 32B, which are printed on the same side of the substrate 30. A silicone type material may be used for insulation 33. With buss bar assembly 20 installed, each of phase bars 32A, 32B, and 32C is in electrical communication with a circumferentially distributed plurality of stator windings associated with the respective first, second, and third electrical phases, A, B, and C. Referring to FIG. 1, the coil winding assemblies 50 are arranged in a repeating sequence of first, second, and third phase coil winding assemblies 50A, 50B, and 50C, six of each, totaling eighteen coil winding assemblies 50 having neutral and phase lead terminals respectively adjacently spaced at 20°. The buss bar assembly 20 is optionally provided with neutral bar 32N, which is shown in the depicted embodiment. If neutral bar 32N is omitted, the neutral leads of the various stator coil winding phases are interconnected with each other externally of the buss bar assembly 20. In FIG. 1, the phase and neutral leads of the arranged plurality of eighteen coil winding assemblies are indicated alphanumerically showing the phase A, B, or C, or neutral N, and the coil winding assembly number, 1-18. Thus, the stator's individual first phase terminals are identified A1, A4, A7, A10, A13, and A16; the stator's individual second phase terminals are identified B2, B5, B8, B11, B14, and B17; the stator's individual third phase terminals are identified C3, C6, C9, C12, C15, and C18. The stator's individual neutral terminals are identified N1-N18. In FIGS. 2-4, the corresponding phase and neutral bar terminals 66 of the buss bar assembly 20 are likewise identified. First, second, and third phase power terminals for each phase bar, through which electrical power is transferred to or from the electrical machine through the buss bar assembly 20, are identified as AP, BP, and CP, respectively, in FIGS. 3 and 4.

The bars 32 on each side of the substrate 30 are generally concentric. Plate assembly 28 has a plurality of circumferentially distributed pairs of apertures 34 by which it is mounted within housing 22. As shown, eighteen pairs of apertures 34 may be provided, spaced from each other at 20° intervals. Relative to each pair of apertures 34, the apertures 34 are radially aligned with the central axis of the annular substrate 30, which is coaxial with the central axis of the housing 22 at first and second radii R1 and R2 (see FIGS. 3 and 4). The apertures 34 are all configured as right cylinders whose central axes are parallel and normal to the planar surfaces of the substrate 30.

Housing base 24 is provided with a plurality of circumferentially distributed pairs of buss bar plate assembly mounting members 40. As shown, eighteen pairs of mounting members 40 may be provided, spaced from each other at 20° intervals. Relative to each pair of mounting members 40, the mounting members 40 are radially aligned with the central axis of the annular housing base 24. The central axes of the mounting members 40 are parallel and project normally relative to the flat, parallel surfaces of the substrate 30. The apertures 34 and mounting members 40 cooperatively mate with each other, as shown in the Figures.

The radially inner cylindrical wall of the housing base 24 may be provided with a circumferentially distributed plurality of radially inner openings 42 if the buss bar assembly includes a neutral bar 32N, as shown. The flat, annular substrate 30 lies in a plane 44 that is perpendicular to the central axis of the buss bar assembly 20. With cover 26 attached to base 24, a plurality of windows 42 is defined, through which plane 44 extends. A tab portion 46 of the substrate 30 projects radially inwardly through each window 42. When the buss bar assembly 20 is installed relative to the stator, a neutral lead terminal 48 extending from each coil winding assembly 50 electrically engages the portion of the neutral bar 32N printed on the downwardly facing, bottom side of each tab portion 46, which serves as a neutral bar terminal 66N.

The coil winding assemblies 50 define a plurality 52 of coil winding assemblies alternatingly arranged by electrical phase A, B, C about the axis 54 of a stator assembly 56, which coincides with and also identifies the buss bar assembly central axis. Thus, stator 56 has an equal number (here, six) of first phase coil winding assemblies 50A, second phase coil winding assemblies 50B, and third phase coil winding assemblies 50C; the individual coil winding assemblies 50A, 50B, or 50C are interconnected through their respective phase bar 32A, 32B, or 32C when the buss bar assembly 20 is installed onto the arranged plurality of coil winding assemblies 52. The buss bar housing base 24 includes a circumferentially distributed plurality of first feet 58, each of which is provided with an aperture 60. The coil winding assemblies 50 each include an injection molded insulator from which extends an integral retention pin 62 that is received into the housing base foot aperture 60. Subsequent to retention pin insertion through the first feet 58, the terminal ends of the pins 62 are plastically deformed to provide a head larger than the diameter of aperture 60, and thereby fixing the buss bar assembly to the stator 56.

The radially outer cylindrical wall of the housing base 24 is provided with a circumferentially distributed plurality of radially outer openings 64 through which radially outwardly extends tab portions 67 of the substrate 30. Tab portions 67 project radially outwardly in the respective plane 44 through associated opening 64A, 64B, or 64C. The portions of the phase bars 32A, 32B, and 32C printed on the substrate tab portions 67 define, or may be additionally provided with, a circumferentially distributed plurality of integral phase terminals 66A, 66B, or 66C. Phase lead terminals 68 extend from the coil winding assemblies 50, and electrically engage a respective one of the buss bar assembly phase terminals 66. Thus, first phase lead terminals 68A of coil winding assemblies 50A electrically engage first phase bar 32A through connections to first phase terminals 66A; second phase lead terminals 68B of coil winding assemblies 50B electrically engage second phase bar 32B through connections to second phase terminals 66B; and third phase lead terminals 68C of coil winding assemblies 50C electrically engage third phase bar 32C through connections to third phase terminals 66C. In the depicted embodiment, the neutral lead terminals 48 of all coil winding assemblies 50 electrically engage neutral bar 32N through connections to neutral terminals 66N.

The buss bar housing base 24 has second feet 70 through which the phase lead terminals 68 extend and which partially electrically isolate the terminals 68. Shields 72 formed on the injection molded plastic housing cover 26 cooperate with the housing base second feet 70 to enclose the connection between the phase bar terminals 66 and the phase lead terminals 68, and more fully electrically isolate the these terminals.

Referring to FIG. 2, the buss bar plate assembly mounting members 40 each have a segmented surface 76 defined by first and second right cylindrical portions 78, 79 of relatively larger and smaller diameters, respectively. The smaller diameter mounting member second portions or segments 79 are received into apertures 34 with a close fit. The annular axial surface of each larger diameter mounting member first portion or segment 78 defines a shoulder 80 too large to permit insertion of the first portion 78 into an aperture 34. With buss bar plate assembly 28 engaged with mounting members 40, the bottom surface 82 of the plate assembly 28 has surface-to-surface contact with shoulders 80 at a fixed position along the parallel axes 74, and relative to housing 22. Thus, the axial position of the plate assembly 28 is established through the abutting contact of the plate assembly bottom surface 82 and the mounting member annular shoulders 80. The terminal end or tip 88 of each mounting member 40 engages the interior side of the housing cover 26, retaining the plate assembly 28 in its position relative to the housing 22. The housing base 24 and cover 26 may be interconnected and retained together through snap lock features (not shown) provided in the housing base 24 and cooperating features (not shown) in the housing cover 26.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A buss bar assembly for a multiphase electrical machine, comprising:
a substantially annular dielectric housing having a central axis;
a plurality of dielectric mounting members located within the housing; and
a buss bar plate assembly disposed in the housing, and in engagement with the mounting members, the buss bar plate assembly comprising:
a substantially planar dielectric substrate that has opposing, substantially planar axial sides, and substantially surrounds the central axis, and
a plurality of electrically conductive phase bars applied to at least one of the opposing substrate sides, each phase bar being for electrical connection to a different one of multiple electrical phases and substantially surrounds the central axis, the phase bars being electrically isolated from each other within the housing.

2. The buss bar assembly of claim 1, wherein each of the plurality of mounting members is connected to the substantially annular dielectric housing.

3. The buss bar assembly of claim 1, wherein each phase bar includes a terminal for electrical connection to a different one of multiple electrical phases, and the substantially annular dielectric housing defines a space in which the buss bar plate assembly is located and a wall having openings through which the phase bar terminals extend from the space.

4. The buss bar assembly of claim 1, wherein the housing has feet for fixing the buss bar assembly to a multiphase electrical machine stator.

5. The buss bar assembly of claim 1, wherein the buss bar plate assembly is provided with a plurality of apertures extending between the opposing axial sides of the substrate, through which a mounting member extends, and the buss bar plate assembly and the mounting members are in abutting engagement at locations along the mounting members in directions generally parallel with the central axis.

6. The buss bar assembly of claim 5, wherein the plurality of mounting members is distributed about the central axis.

7. The buss bar assembly of claim 5, wherein each mounting member is defined by axially adjacent segments of different cross-sectional sizes between which is located a shoulder with which the buss bar plate assembly is in abutting engagement.

8. The buss bar assembly of claim 1, wherein each mounting member is an integrally formed portion of the housing, each mounting member has an axis along which the mounting member extends in directions generally parallel with the central axis, and each mounting member is in abutting engagement with the buss bar plate assembly.

9. The buss bar assembly of claim 1, wherein the buss bar plate assembly comprises an electrically conductive neutral bar applied to one of the opposing substrate sides for electrical connection to multiple electrical phases, the neutral bar substantially surrounds the central axis, and the neutral bar is electrically isolated from the phase bars within the housing.

10. The buss bar assembly of claim 9, wherein each phase bar includes a terminal for electrical connection to a different one of multiple electrical phases, the neutral bar includes terminals for electrical connection to multiple electrical phases, and the substantially annular dielectric housing defines a space in which the buss bar plate assembly is located and at least one wall having openings through which the neutral bar terminals and phase bar terminals extend from the space.

11. The buss bar assembly of claim 9, wherein the buss bar plate assembly is provided with a plurality of apertures extending between the opposing axial sides of the substrate and through which a mounting member extends, the buss bar plate assembly and the mounting members in abutting engagement at locations along the mounting members in directions generally parallel with the central axis.

12. The buss bar assembly of claim 11, wherein each mounting member is defined by axially adjacent segments of different cross-sectional sizes between which is located a shoulder with which the buss bar plate assembly is in abutting engagement.

13. The buss bar assembly of claim 9, wherein each mounting member has first portion connected to the housing, and a second portion axially adjacent and connected to the first portion, the substrate is provided with an aperture extending between its opposing axial sides, each mounting member first portion is restricted from insertion into an aperture, and each aperture surrounds a respective mounting member second portion.

14. The buss bar assembly of claim 13, wherein each aperture is substantially cylindrical and the first and second portions of each mounting member respectively define axially adjacent cylindrical segments of different cross-sectional sizes between which is located a shoulder with which the buss bar plate assembly is in abutting engagement.

15. A method for manufacturing a buss bar assembly for a multiphase electrical machine, comprising:
providing a buss bar plate assembly having a plurality of electrically conductive phase bars, each phase bar for electrical connection to a different one of multiple electrical phases, the phase bars applied onto at least one of a pair of opposing, substantially planar axial sides of a dielectric substrate, the phase bars electrically isolated from each other on the substrate;
substantially surrounding the central axis of an annular dielectric housing with the substrate and disposing the buss bar plate assembly in the housing such that each buss bar is electrically engageable from outside of the housing; and
engaging the buss bar plate assembly with a plurality of dielectric mounting members fixed within the housing, whereby the buss bar plate assembly has a fixed position relative to the housing.

16. The method of claim 15, wherein the providing of a buss bar plate assembly includes providing a buss bar plate assembly having an electrically conductive neutral bar for electrical connection to multiple electrical phases applied to one of the axial sides of the substrate, the neutral bar electrically isolated from the phase bars on the substrate; and comprising:
disposing the buss bar plate assembly in the housing such that the neutral bar is electrically engageable from outside of the housing.
